(19) United States
(12) Patent Application Publication
(10) Pub. No.: US 2005/0271891 A1
(43) Pub. Date: Dec. 8, 2005

(54) Metal-ceramic joined article and production method

(75) Inventors: Kaoru Kuzuoka, Toyota-city (JP); Katsunori Yamada, Nagoya-city (JP); Takao Kobayashi, Seto-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/145,315

(22) Filed: Jun. 3, 2005

(30) Foreign Application Priority Data
Jun. 7, 2004 (JP) 2004-168254 (PAT.

(51) Int. Cl. B32B 15/04

(52) U.S. Cl. 428/623; 428/633

(57) ABSTRACT

A metal-ceramic joined article comprises a ceramic member, a thin metal layer joined onto the surface of the ceramic member and a surface layer, formed on the surface of the thin metal layer, having the function to prevent carbon and/or nitrogen diffusing into the thin metal layer. The thin metal layer contains a first oxide film forming element capable of forming a first oxide film having the function to suppress carbon and/or nitrogen from diffusing into the thin metal layer, and the surface layer preferably comprises the first oxide film formed by oxidizing the surface of the thin metal layer before joining.

### BACKGROUND OF THE INVENTION

1. Field of the Invention

The present invention relates to a metal-ceramic joined article, and particularly to a metal-ceramic joined article that can maintain mechanical and functional properties over a long period of time even when used in oxidizing atmosphere at a temperature of 600° C. or higher.

2. Description of Related Art

Metal-ceramic joined articles have been used in various structural components that must satisfy requirements related to mechanical properties such as strength at high temperatures, wear resistance and heat resistance, and in various functional components that must satisfy requirements related to electromagnetic properties such as electric conductivity and ion conductivity and to heat conductivity. The metallic material or member and the ceramic material or member may be joined together by a mechanical method such as using bolts or fitting, an adhesive method that employs organic or inorganic adhesive agent, a metalizing-brazing method where a ceramic member is metalized to form a thin metal film on the surface thereof and is joined with a metallic member via the thin metal film by brazing, a plating method where a thin metal film is formed on the surface of a ceramic member by electroless plating, a diffusing joining method wherein a metallic member and a ceramic member are put together directly or via an appropriate brazing material, an intermediate layer or the like and are joined together by heating to a high temperature to cause constituent elements to diffuse through the interface, or by physical film forming method such as CVD, electron beam, sputtering, laser abrasion or vapor deposition. The diffusion-joining method includes a field-assisted bonding method (a method using application of an electric field) where a reaction at the interface is forcibly caused by using the properties of ions of the constituent elements thereby to achieve diffusion-joining.

While these joining methods are chosen in accordance to the application of the metal-ceramic joined article, chemical processes such as a metalizing method and a diffusion-joining method are commonly employed in applications that require high reliability. However, chemically joining a thin metallic member and a ceramic member that are different in nature gives rise to various problems.

For example, in order to join the thin metal layer and the ceramic member by a chemical joining method, both members must be heated to a high temperature. As a ceramic material generally has a thermal expansion coefficient lower than that of a metallic material, when both members are heated to a high temperature so as to join with each other and then cooled to room temperature, a thermal stress (tensile stress) is caused in the ceramic member due to the difference in the thermal expansion coefficients. When the thermal stress is higher than the mechanical strength of the ceramic member, the ceramic member fractures.

For solving this problem, a method of interposing a material (for example, W, Wo, Zr, Nb, etc.) having thermal expansion coefficient of an intermediate value between those of the thin metallic member and the ceramic member between both members, a method of interposing a soft metal (for example, Al, Au, Cu, etc.) in the interface between the thin metallic member and the ceramic member, and other methods have been proposed.

Japanese Unexamined Patent Publication (Kokai) No. 2003-212670 discloses a method of joining members in solid phase wherein a Ti foil and a pure Au brazing material are disposed on an AlN substrate and are heated to melt so as to form an Au precoat layer, then a pure Cr plate 2 mm in thickness, a pure Au foil 200 μm in thickness, an Inconel strip 20 mm in length and an Ni terminal are placed one on the other in this order on the Au precoat layer, and are joined in solid phase under pressure. This patent document describes that, if ceramic member and a metallic member are joined together via an Au brazing material, an increase in the yield point of the Au brazing material due to the diffusion of Ni contained in the metallic material into the Au brazing material can be suppressed by providing the Cr plate between the metallic member and the Au brazing material.

If metal-ceramic joined article is to be used in high temperature oxidizing atmosphere, a heat resistant material having heat resistance and oxidization resistance is used for the metallic member. When a chemical joining method is employed, materials having high melting points are used for the brazing material, the intermediate layer, etc. For the acceleration of diffusion of the constituent element through the interface, the members are joined usually under pressure and at a temperature higher than the temperature at which the product of the joining is to be used. In such a case, it is a common practice to use a fixture made of carbon, that has excellent high-temperature strength, to apply pressure to the interface.

However, when a fixture or jig made of carbon is used to apply a pressure to the metal-ceramic interface, carbon tends to diffuse into the metallic member during the joining step. Also, the surface of the fixture made of carbon is often coated with a release agent such as BN, in which case N contained in the release agent may diffuse into the metallic member during the joining step. Moreover, a heat resistant material contains various elements added to provide heat resistance and oxidization resistance, and carbon or nitrogen diffusing into the heat resistant material may react with such additive elements to form a carbide or a nitride. Particularly when the metallic member to be joined with the ceramic member is relatively thin, the additive elements contained in the metallic material may be consumed in forming the carbide or the nitride, thus resulting in a significant decrease in the heat resistance and/or oxidization resistance of the metallic member.

A conventional heat resistant material contains elements (for example, Al, Cr, Si, etc.) that form dense oxides. When such a heat resistant material is exposed to high temperature oxidizing atmosphere, a dense oxide film is formed on the surface, and the oxide film keeps oxygen from diffusing, so as to suppress oxidization of the heat resistant material from proceeding.

These elements, as they have high levels of activity, may diffuse into the metal-ceramic interface and form stable compounds through reaction with the ceramic material, when the heat resistant material and the ceramic material are put together and heated to a high temperature. Particularly when the metallic member to be joined with the ceramic member is thin, these elements contained in the metallic material are depleted and, as a result, it become difficult to form the oxide film on the surface of the metallic member. This not only makes it difficult to ensure short-term protection against oxidation but also makes it impossible to provide a long-term supply of these elements to the surface of the metallic member with a sufficient concentration, thus resulting in a decrease in durability.

A solution to this problem may be to increase the thickness of the metallic member and increase the amount of these elements contained in the metallic member. When the metallic member is made thicker, however, residual stress caused by the joining step may increase and cause exfoliation at the metal-ceramic interface or on the ceramic member side. The residual stress may be mitigated by interposing an intermediate layer having a thermal expansion coefficient of a value between those of the metallic member and the ceramic member. However, it is difficult to choose a proper material for the intermediate layer that satisfies the requirements of heat resistance and oxidization resistance at a high temperature. Furthermore, as the structure having the intermediate layer is complicated, in the junction, this method cannot be applied to functional components that are required to be small in size and low in cost. With the method that uses a soft metal to mitigate the residual stress, on the other hand, heat resistance of the metal-ceramic joined article may be compromised by the presence of the soft metal.

A method may also be conceived that employs a metallic material containing a high content of elements that form a dense oxide film, so as to improve the heat resistance and/or oxidization resistance as well as durability of the metallic member. However, excessive content of these elements in the metallic material makes the metallic material less workable, meaning that it becomes difficult to form a thin metal film, thus leading to an increasing production cost of the joined article.

### SUMMARY OF THE INVENTION

An object of the present invention is to mitigate the carbonization and/or nitriding of the metallic member and the accompanying decreases in the electric property, thermal conductivity and mechanical properties such as strength, ductility, heat resistance and/or oxidization resistance that are intrinsic to the metallic material, caused by the diffusion of carbon and/or nitrogen from the fixture made of carbon into the metallic member when joining the metal and ceramic to make the metal-ceramic joined article used in a high-temperature oxidizing atmosphere.

Another object of the present invention is to mitigate the decrease in the heat resistance and oxidization resistance as well as the decrease in durability of the metallic member caused by the diffusion of elements, that form a dense metal oxide film on the metal member surface, from the metal-ceramic interface into the ceramic member during heat treatment in the joining step of the metal-ceramic joined article used in high temperature oxidizing atmosphere.

Further, another object of the present invention is to reduce the production cost for the metal-ceramic joined article that has favorable properties in the heat resistance and/or oxidization resistance and durability.

In order to solve the problems described above, the metal ceramic joined article of the present invention comprises a ceramic member, thin metal members (both sides of the ceramic member) joined onto the surface of the ceramic member and a dense metal oxide film that is formed on the surface of the metal member and has a function to suppress carbon, nitrogen and/or oxygen from diffusing into the thin metal layer.

It is preferred that the metal oxide layer on the surface of the metal member is formed from the first metal oxide film forming element that is capable of forming a first oxide film having function to suppress carbon and/or nitrogen from diffusing into the thin metal layer, and the surface layer comprises the first oxide film formed by oxidizing the surface of the thin metal layer before joining the members.

The surface layer may contain a higher content of a second oxide film forming element that is capable of forming a second oxide film, which has a function to suppress oxygen from diffusing into the thin metal layer, than the thin metal layer has. The surface layer may also further comprise the second oxide film that is formed by oxidizing the surface thereof after the joining step.

A method for producing a metal-ceramic joined article according to the present invention comprises an oxidation step wherein the surface of the thin metal layer that contains the first oxide film forming element is oxidized so as to form the first oxide film on at least one of the surfaces of said thin metal layer, and a joining step wherein the thin metal layer and the ceramic member are placed one on the other and are subjected to heat treatment under pressure.

A second method for producing a metal-ceramic joined article of the present invention comprises a surface layer forming step wherein a surface layer, that contains a higher content of the second oxide film forming element than that of the thin metal layer, is formed on at least one of the surfaces of the thin metal layer, and a joining step wherein the thin metal layer and the ceramic member are placed one on the other and are subjected to heat treatment while applying a pressure, so that the surface layer lies on the outside. In this case, an oxidation step may also be provided to oxidize the surface layer after the joining step so as to form a second oxide film on the outermost layer.

When the surface of the thin metal layer that contains the first oxide film forming element is oxidized before joining, the first oxide layer is formed on the surface. As the thin metal film is placed on the ceramic member and is pressurized by means of a fixture or jig made of carbon, which may be coated with a release agent as required, the first oxide film functions to suppress carbon and/or nitrogen from diffusing into the thin metal layer. As a result, a decrease in the functional properties such as heat resistance and/or oxidization resistance as well as in the mechanical properties of the thin metal layer due to carbonization, carburization or nitriding can be suppressed.

When the surface layer that contains a higher content of the second oxide film forming element than that of the thin metal layer is formed on the surface of the thin metal layer, the amount of the second oxide film forming element contained in the thin metal layer and in the surface layer increases. As a result, even when the second oxide film forming element is consumed in the metal-ceramic interface during the joining step, the heat resistance and/or oxidization resistance and durability of the thin metal layer can be maintained. Also because it is not necessary to use a material that contains relatively high content of the second oxide film forming element for the thin metal layer or to increase the thickness of the thin metal layer, cost of producing the metal-ceramic joined article can be prevented from increasing. The present invention is effective for joining a metallic member and a ceramic member by the field-assisted bonding method which consumes much of the oxide film forming element in the interface between both members.

### BRIEF DESCRIPTION OF THE DRAWINGS

FIG. 1 shows photographs showing a concentration distribution of aluminum on a surface of the metal foil of the metal-ceramic joined article in which the photograph (A) represents Example 2 and the photograph (B) represents Comparative Example 1.

### DESCRIPTION OF THE PREFERRED EMBODIMENTS

Embodiments of the present invention will now be described in detail. The metal-ceramic joined article of the present invention comprises a ceramic member, a thin metal layer joined onto the surface of the ceramic member and a surface layer formed on the surface of the thin metal layer.

According to the present invention, there is no limitation to the kind of ceramic material, and the present invention can be applied to various structural ceramic materials or functional ceramic materials. There is also no limitation to the shape of the ceramic member, and the present invention can be applied to ceramic members having various shapes.

The ceramic material may specifically be as follows:
(1) nitrides such as silicon nitride (Si₃N₄), aluminum nitride (AlN), gallium nitride (GaN), titanium nitride (TiN) and zirconium nitride (ZrN);
(2) carbides such as silicon carbide (SiC), titanium carbide (TiC), zirconium carbide (ZrC) and boron carbide (B₄C)
(3) oxides such as alumina (Al₂O₃), zirconia (ZrO₂), molybdenum oxide (MoOₓ), ceria (CeO₂), yttria (Y₂O₃), bismuth oxide (Bi₂O₃), barium titanate (BaTiO₃), titania (TiO₂), zinc oxide (ZnO), magnesia (MgO), calcia (CaO) and spinel (Al₂MgO₄)
(4) borides such as titanium boride (TiB₂) and zirconium boride (ZrB₂)
(5) silicates such as titanium silicate (TiSi₂) and zirconium silicate (ZrSi₂)
(6) pyrochlore oxides such as La₂Zr₂O₇, Sm₂Zr₂O₇ and Gd₂Zr₂O₇
(7) oxides having perovskite structure such as SrCe₁₋ₓMₓO₃ (M=Sc, Zn, Y, Mn, In, Nd, Sm, Dy, Yb), La₁₋ₓCaCrO₃, La₁₋ₓSrCrO₃, YMnO₃, La₁₋ₓCoₓMnO₃, LaSrMnO₃, LaFeO3, La₁₋ₓCaₓCO₃, La₁₋ₓSrₓCoO₃, SrCeO₃, CaZrO₃, SrZrO₃, BeZrO₃, BaCeO₃, BaCe₁₋ₓGdₓO₃ and CaHfO₃, KTaO₃.
   A composite ceramic material constituted from two or more of those listed above may also be used.

According to the present invention, there is no restriction on the composition of the thin metal layer, and various materials may be used in accordance to the composition of the ceramic material, application of the metal-ceramic joined article, required properties and other factors. In order to obtain a metal-ceramic joined article having good properties of heat resistance and/or oxidization resistance as well as durability, however, it is preferred that the thin metal layer satisfies the following requirements.

First, the thin metal layer is preferably made of a material having high heat resistance and high oxidization resistance (such a material will hereinafter be referred to as “oxidization resistant & heat resistant material”).

As will be described later, the thin metal layer can be rendered heat resistant and oxidization resistant by forming a certain type of surface layer on the thin metal layer and causing particular element to diffuse from the surface layer into the thin metal layer. Accordingly, the thin metal layer is not necessarily required to be an oxidization resistant & heat resistant material. But the use of an oxidization resistant & heat resistant material for the thin metal layer provides such a merit as deterioration of the thin metal layer due to carbon, nitrogen and/or oxygen can be restricted more effectively, so that the metal-ceramic joined article having high heat resistance, high oxidization resistance and high durability can be obtained.

Second, the thin metal layer preferably contains the first oxide film forming element capable of forming the first oxide film. The “first oxide film” used herein refers to an oxide film that is formed by oxidizing the surface of the thin metal layer and has the function to suppress carbon and/or nitrogen from diffusing into the thin metal layer.

When pressure is applied to the stack of thin metal layer and the ceramic member by means of a fixture made of carbon (or one that is coated with a release agent such as BN or the like) during the joining step, carbon and/or nitrogen diffuses from the fixture into the thin metal layer. If the thin metal layer is relatively thick, it is possible to remove only the region that contains carbon and/or nitrogen diffused therein after joining. Thus the thin metal layer is not necessarily required to contain the first oxide film forming element. However, if the thin metal layer contains the first oxide film forming element, carbon and/nitrogen can be suppressed from diffusing into the thin metal layer from the surface of the fixture made of carbon during the joining step without the need to increase the thickness of the thin metal layer.

In order to function to suppress carbon and/or nitrogen from diffusing into the thin metal layer, the first oxide film is preferably formed from an oxide that is hard to reduce by carbon at the joining temperature. For this reason, the first oxide film is preferably made of a metal oxide that has a generated free energy of 400 kJ/mol or less at 900° C.

As such an oxide, Al₂O₃, Cr₂O₃, SiO₂, MgO, CaO, TiO₂, ZnO, Nb₂O₅, MnO, Mn₃O₄, Ce₂O₃, Ta₂O₅, etc., or a composite oxide containing at least one of these may be used. Among these oxides, Al₂O₃ is stable at high temperatures and is particularly preferable for the first oxide film.

As the “first oxide film forming element”, Al, Cr, Si, Nb, Ni, Mn, Ce, Mg, Ca, Ti, Zn, Ta or the like may be used. The thin metal layer may contain either one of these first oxide film forming elements, or two or more thereof. The concentration of the first oxide film forming element contained in the thin metal layer is set to an optimum level according to the composition of the thin metal layer and the kind of the first oxide film forming element, so that diffusion of carbon into the thin metal layer can be suppressed without compromising the workability of the thin metal layer.

Third, the thin metal layer preferably contains, in addition to or instead of the first oxide film forming element described above, a second oxide film forming element that is capable of forming a second oxide film. Here, the “second oxide film” refers to an oxide film that has an effect of suppressing the diffusion of oxygen into the thin metal layer.

As will be described later, the second oxide film can be formed by forming a surface layer that contains the second oxide film forming element on the surface of the thin metal layer and oxidizing the surface layer. Therefore, the thin metal layer is not required to contain the second oxide film forming element. When the thin metal layer contains the second oxide film forming element, however, a larger amount of the second oxide film forming element is contained in the thin metal layer and in the surface layer, and it is advantageous because the metal-ceramic joined article having high heat resistance and/or high oxidization resistance as well as high durability can be produced.

In order to suppress the diffusion of oxygen into the thin metal layer, the second oxide film is preferably made of an oxide that has high resistance against exfoliation, high resistance against oxidization, stability and high density. For this purpose, the second oxide film is preferably formed from a metal oxide that has a generated free energy of 400 kJ/mol or less at 900° C.

As such an oxide, Al₂O₃, Cr₂O₃, SiO₂, MgO, CaO, TiO₂, ZnO, Nb₂O₅, MnO, Mn₃O₄, Ce₂O₃, Ta₂O₅, etc., or a composite oxide containing at least one of these may be used.

As the “second oxide film forming element”, Al, Cr, Si, Nb, Mn, Ni, Ce, Mg, Ca, Ti, Zn, Ta or the like may be used. The thin metal layer may contain either one of these second oxide film forming elements, or two or more thereof.

The concentration of the second oxide film forming element in the thin metal layer is set to an optimum level according to the composition of the thin metal layer and the kind of the second oxide film forming element, so that diffusion of oxygen into the thin metal layer can be suppressed without compromising the workability of the thin metal layer. In order to obtain a metal-ceramic joined article having high heat resistance, high resistance to oxidization and high durability, the content of the second oxide film forming element contained in the thin metal layer is preferably such that is enough to maintain the second oxide film over a long period of time.

More specifically, the content of the second oxide film forming element in the thin metal layer is preferably such that can maintain the second oxide film for a period of 100 hours under use conditions at temperatures of 1000° C. and higher. Content of the second oxide film forming element in the thin metal layer is preferably 5% by weight or more. A material that contains 5% by weight or more of Al, in particular, is preferably used as the thin metal layer.

Fourth, the thin metal layer preferably contains, in addition to or instead of the first oxide film forming element and/or the second oxide film forming element described above, a oxide film stabilizing element. Here, the “oxide film stabilizing element” refers to an element that has an effect of stabilizing the first oxide film and/or the second oxide film formed on the surface of the thin metal layer.

Oxide films formed on the surface of metallic members are generally known to contain those having high tenacity to the base metallic material and those that do not. In case the oxide film having low tenacity with the base metallic material, tenacity of the oxide film with the base material can be improved so as to prevent exfoliation of the oxide film by adding a certain element (oxide film stabilizing element) to the metallic material. According to the present invention, although addition of the oxide film stabilizing element is not a necessity, use of the thin metal layer containing the oxide film stabilizing element enables it to obtain a metal-ceramic joined article that can maintain heat resistance and/or oxidization resistance even when it is used in high temperature oxidizing atmosphere for an extended period of time.

As the oxide film stabilizing element, rare earth elements such as Y, Yb, La, Ce, Ta, Th or the like may be used. The oxide film stabilizing element may be contained either in the form of metal element or in the form of oxide or composite oxide in the thin metal layer. The thin metal layer may also contain one or more kinds selected from among the oxide film stabilizing elements described above. It is particularly preferred that the thin metal layer contains both of one element selected from the first oxide film forming elements such as Al, Cr and Si and/or the second oxide film forming elements, and a rare earth element.

The content of the oxide film stabilizing element in the thin metal layer is set to an optimum level according to the composition of the thin metal layer and the kind of the oxide film stabilizing element, so that tenacity of the oxide film can be improved without compromising the workability of the thin metal layer.

The thin metal layer may be formed from the following materials:
(1) oxidization resistant and heat resistant material such as Fe—Cr—Al alloy, Ni—Cr—Al alloy, Fe—Cr—Si alloy, Fe—Cr—Y alloy, Fe—Cr—La alloy, Cr—Fe—Al—Ni alloy, Cr—Fe alloy, Ni—Cr—Mo—Fe alloy, Ni—Cr—Fe alloy, Cr—Ni—Fe alloy and Cr—Al—Fe—Y alloy; and
(2) heat resistance material such as W, Nb, Zr, Ta, Ti, Ni, Pt, In, La, Pd, Au, Sm, Cu, Gd, Si, Co, Y, Yb, Fe, Sc, Pd, Ru, Ti, Th, Cr, Hf, Ir, Mo, Re, etc. or an alloy of these metals.

The thickness of the thin metal layer is preferably relatively small. When the thin metal layer is thick, a residual stress (tensile stress) may be generated in the ceramic member after joining and may break the ceramic member. Thickness of the thin metal layer is preferably 80 μm or less, and more preferably 30 μm or less.

When the thin metal layer is too thin, on the other hand, durability of the thin metal layer may become lower due to smaller content of the first oxide film forming element and/or the second oxide film forming element contained in the thin metal layer. It may also make the thin metal layer susceptible to breakage during the joining step. Thickness of the thin metal layer is preferably 1 μm or more, more preferably 5 μm or more.

When the thin metal layer and the ceramic member are joined together by a chemical joining method, a diffusion layer (reaction layer) is generally formed in the interface. The diffusion layer formed on the ceramic member side is preferably thin. When the diffusion layer is thick, the diffusion layer may crack and make the thin metal layer susceptible to exfoliation. Thickness of the diffusion layer is preferably 20 μm or less, more preferably 10 μm or less.

There is no restriction on the combination of the thin metal layer and the ceramic member, and various combinations may be selected according to the application of the metal-ceramic joined article.

In order to obtain a metal-ceramic joined article having high heat resistance, however, it is preferable to select a combination of the thin metal layer and the ceramic member that forms a diffusion layer having a melting point higher than that of the thin metal layer in the interface after joining.

Silicates of Pt and Ni, for example, are known to have melting point lower than that of Pt or Ni. Therefore, in case either the thin metal layer or the ceramic member contains Pt and/or Ni, it is preferable that the other member does not contain Si so that a silicate of Pt or Ni will not be formed in the interface.

The surface layer is formed from a material that has the function to prevent carbon, nitrogen and/or oxygen from diffusing into the thin metal layer. Specifically, the surface layer is preferably formed as follows.

A first example of the surface layer comprises the first oxide film formed by oxidizing the surface of the thin metal layer, that contains the first oxide film forming element, before joining.

When the surface of the thin metal layer is oxidized before joining in case the thin metal layer contains the first oxide film forming element described above, the first oxide film that has the function to suppress carbon and/or nitrogen from diffusing can be formed on the surface. As a result, a decrease in heat resistance and/or oxidization resistance and mechanical properties due to carbonization (carburization) and/or nitriding of the thin metal layer can be suppressed even when the thin metal layer and the ceramic member are placed one on the other and are pressurized by means of a fixture made of carbon at a high temperature. In case the first oxide film has the function of suppressing the diffusion of oxygen as well, a decrease in heat resistance and/or oxidization resistance due to the oxidization of the thin metal layer after joining can also be suppressed.

A second example of the surface layer comprises a layer formed from a noble metal such as platinum or rhodium on the surface of the thin metal layer.

Since a noble metal element has low affinity with carbon, diffusion of carbon from the fixture made of carbon into the thin metal layer can be suppressed by forming a layer formed from a noble metal on the surface of the thin metal layer. Also, because a noble metal in general has high resistance against oxidization, diffusion of oxygen into the thin metal layer can be suppressed, when the metal-ceramic joined article is exposed to high temperature oxidizing atmosphere, by forming a layer formed from a noble metal on the surface of the thin metal layer.

A third example of the surface layer comprises a layer that contains a higher content of the second oxide film forming element than in the thin metal layer. In this case, the surface layer may contain, in addition to the second oxide film forming element, the first oxide film forming element and/or the oxide film stabilizing element.

A layer that contains a higher content of the second oxide film forming element than in the thin metal layer can be formed on the surface of the thin metal layer by employing various methods to be described later. The surface layer may include a graded concentration layer, carbonized/carburized layer, nitrided layer or the like depending on the material that forms the thin metal layer, kind of the second oxide film forming element, production condition and other factors.

The “graded concentration layer” refers to a layer that is made of at least the same element as that of the thin metal layer and contains the second oxide film forming element with the concentration thereof changing from the surface to the inside of the thin metal layer. Concentration of the second oxide film forming element in the graded concentration layer may change either continuously or stepwise in distinctive layers. In the case of stepwise distribution, the number of layers may be one or two or more.

Such a graded concentration layer is obtained by forming a layer consisting only of the second oxide film forming element or an intermetallic compound layer that contains a relatively large content of the second oxide film forming element on the surface of the thin metal layer, and causing the second oxide film forming element to diffuse from the surface to the inside of the thin metal layer. The layer consisting only of the second first oxide film forming element or the intermetallic compound layer that contains a relatively high content of the second oxide film forming element may be either left to remain and form a part of the surface layer, or disappear through diffusion, melting, reaction, etc., depending on the joining conditions.

Further, the “nitrided layer” refers to a layer formed as nitrogen diffuses from the surface of the fixture made of carbon during the joining step.

Furthermore, the “carbonized/carburized layer” refers to a layer formed as carbon diffuses from the surface of the fixture made of carbon during the joining step. The surface layer may include a carbonized/carburized layer. However, in case an electrode or other metallic component is bonded onto the surface layer after joining the thin metal layer and the ceramic member, it is preferable to remove the carbonized/carburized layer from the surface layer after joining.

When the layer that contains a relatively high content of the second oxide film forming element is formed on the surface of the thin metal layer by one of the methods to be described later, a larger amount of the second oxide film forming element is contained in the thin metal layer and in the surface layer. As a result, a decrease in the heat resistance and/or oxidization resistance as well as in durability can be suppressed even when the second oxide film forming element has been consumed in the metal-ceramic interface during the joining step.

Also, because the second oxide film forming element diffuses from the surface layer into the thin metal layer during the joining step, even the thin metal film made of a material that is low in heat resistance and oxidization resistance (namely a material containing relatively small amount of the second oxide film forming element) can be rendered heat resistant and oxidization resistant.

A fourth example of the surface layer comprises one that comprises a layer containing a relatively large amount of the second oxide film forming element formed on the thin metal layer and the second oxide film obtained by oxidizing the surface of this layer after joining.

The metal-ceramic joined article having the surface layer containing a relatively large amount of the second oxide film forming element formed on the thin metal layer can be used as it is in a high temperature oxidizing atmosphere. When the surface is oxidized before use, however, the second oxide film can be formed on the surface. This process is effective, if the metal-ceramic joined article is used as a functional component, for stabilizing the operation of the functional component. Furthermore, as the thin metal layer and the surface layer contain larger amount of the second oxide film forming element, heat resistance and/or oxidization resistance as well as durability of the metal-ceramic joined article can be significantly improved.

In case the carbonized/carburized layer is contained in the surface layer after joining, the surface layer may be oxidized as it is. However, if an electrode or other metallic component is bonded onto the surface layer after joining the thin metal layer and the ceramic member, it is preferable to remove the carbonized/carburized layer from the surface layer after joining, then bond the electrode or other metallic component as required, and then oxidize the surface layer.

Methods of producing a metal-ceramic joined article according to the present invention will be described below. The metal-ceramic joined article of the present invention can be produced by the methods described below.

A first method is mainly for suppressing the diffusion of carbon and/or nitrogen into the thin metal layer, and comprises an oxidizing step where the thin metal layer that contains the first oxide film forming element is oxidized on the surface so as to form the first oxide layer on at least one surface of the thin metal layer, and a joining step where the thin metal layer and the ceramic member are placed one on the other and are subjected to heat treatment under pressure.

Oxidization of the thin metal layer on the surface thereof is carried out by heating it to a predetermined temperature in air atmosphere. The treatment temperature is set to a proper level in accordance to the composition of the thin metal layer. In the case of an Fe-based or Ni-based heat resistant steel that contains the first oxide film forming element, for example, the heat treatment temperature is preferably in a range from 700° C. to 1,200° C. Duration of heat treatment may be such that the first oxide layer can be formed uniformly on the surface of the thin metal layer. While the optimum duration of the heat treatment depends on the heat treatment temperature, thickness and composition of the thin metal layer and other factors, the duration is normally from several minutes to several hours. If the first oxide layer is formed in advance before joining, the first oxide film may be formed on both sides of the thin metal layer, but is more preferably formed only on one side, namely on the surface that would make the surface of the joined member and not formed on the interface side.

The thin metal layer whereon the first oxide layer is formed and the ceramic member are placed one on the other, and are joined together. At this time, the thin metal layer and the ceramic member may be joined either directly with each other or via a brazing material or an intermediate layer provided between the thin metal layer and the ceramic member.

The temperature and the time of the joining step are appropriately set in accordance to the composition of the thin metal layer and the ceramic member and the composition of the intermediate layer, if used, and the combination thereof. In general, a sufficiently strong joint cannot be obtained when the joining temperature is too low compared to the melting point and/or the joining time is too short. If the joining temperature is much higher than the melting point and/or the joining time is too long, the thin metal layer is melted or the diffusion layer formed on the ceramic member side becomes too thick which is not desirable.

The thin metal layer and the ceramic member are joined while applying a pressure to the metal-ceramic interface. The optimum pressure varies depending on the compositions of the thin metal layer and the ceramic member, the composition of the intermediate layer, if used, the combination thereof, joining temperature and other factors. In general, a sufficiently strong joint cannot be obtained when the joining pressure is too low, because non-contact region may be present in the metal-ceramic interface. When the joining pressure is too high, on the other hand, the thin metal layer and the ceramic member may be deformed.

If a thin metal layer made of an Fe-based or Ni-based heat resistant steel such as Fe—Cr—Al or Ni—Cr—Al and Si₃N₄ are joined together, for example, the joining temperature is preferably in a range from 600 to 1500° C. The joining time and the joining pressure are set appropriately in accordance to the joining temperature.

While the joining step may be simply heating while applying pressure, an electric field may also be applied during the joining step, as in the so-called field-assisted bonding method. Application of the electric a field during the joining step effects a forced reaction in the interface, and it joins the members satisfactorily.

The metal-ceramic joined article thus obtained may be further provided with an electrode or other metallic component, metal wire, metal foil or the like (which will be collectively referred to as metallic components) bonded thereon as required. In this case, the metallic components may be bonded either directly on the first oxide film or via a brazing material or an intermediate layer. Alternatively, the metallic component may be bonded on the surface of the thin metal layer after removing the first oxide layer.

A second method is for suppressing the diffusion of oxygen into the thin metal layer, and comprises a surface layer forming step where a surface layer that contains a higher content of the second first oxide film forming element than in the thin metal layer is formed on at least one surface of the thin metal layer, and a joining step where the thin metal layer and the ceramic member are placed one on the other so that the surface layer faces the outside and are heated while applying a pressure.

In the second method, the thin metal layer may or may not contain the second oxide film forming element. In order to obtain the metal-ceramic joined article of high durability, however, it is preferable that the thin metal layer contains a large content of the second oxide film forming element to such an extent that workability of the layer would not be compromised. The surface layer may be formed either on both sides of the thin metal layer, or only on one side (that makes the outer surface of the joined member) of the thin metal layer by using an appropriate mask.

Especially, the surface layer may be formed on the thin metal layer by the following methods:
(1) a method of placing, on the surface of the thin metal layer, a metal foil made of the second first oxide film forming element, a single-phase metal foil that contains a higher content of the second oxide film forming element than in the thin metal layer, or an alloy foil;
(2) a method of forming a thin film made of only the second oxide film forming element, or a thin film that contains a higher content of the second oxide film forming element than in the thin metal layer, on the thin metal layer by physical technique such as vapor deposition, sputtering, laser abrasion or electron beam;
(3) a method of forming a thin film made of only the second oxide film forming element, or a thin film that contains a higher content of the second oxide film forming element than in the thin metal layer, on the thin metal layer by plating; or
(4) a method of coating the surface of the thin metal layer with a paste that contains a powder made of only the second oxide film forming element, or a powder that contains a higher content of the second oxide film forming element than in the thin metal layer by screen printing, spraying or other process.

The thin metal layer whereon the surface layer is formed and the ceramic member are placed one on the other and are joined together. As the stack of the thin metal layer and the ceramic member is heated to a predetermined temperature, the second oxide film forming element diffuses into the thin metal film, and the surface layer comprising a graded concentration layer, a carbonized/carburized layer or the like is formed on the thin metal layer. Details of the process will be omitted here since this method is similar to the first method in that the thin metal layer and the ceramic member may be joined either directly with each other or via a brazing material or an intermediate layer provided therebetween, in that temperature, time and pressure of the joining step are appropriately set in accordance to the composition of the thin metal layer, and in that an electric field may be applied when joining.

The metal-ceramic joined article thus obtained may be further provided with a metallic component bonded thereon as required. In this case, the metallic component may be bonded either directly on the surface layer, or via a brazing material or an intermediate layer. In case a fixture made of carbon is used to apply a pressure when joining, a carbon layer and carbonized/carburized layer may be formed on the surface layer. The metallic component may be bonded either onto the carbonized/carburized layer after removing the carbon layer, or onto the surface layer after removing the surface layer and the carbonized/carburized layer. It is preferable to bond the metallic component onto the surface layer after removing the surface layer and the carbonized/carburized layer.

This method may also be used for producing a metal-ceramic joined article that has a noble metal layer formed on the thin metal layer in order to suppress the diffusion of carbon from a fixture made of carbon into the thin metal layer, or to suppress the diffusion of oxygen into the thin metal layer.

A third method is for suppressing the diffusion of oxygen into the thin metal layer, and comprises a process of forming a surface layer that contains a higher content of the second oxide film forming element than in the thin metal layer on at least one of the surfaces of the thin metal layer, a joining step where the thin metal layer and the ceramic member are placed one on the other so that the surface layer faces the outside and are heated under a pressure, and an oxidization step where the surface layer is oxidized to form the second oxide layer on the surface.

When the surface layer that contains a relatively high content of the second oxide film forming element is formed on the thin metal layer which is then joined with the ceramic member, a surface layer comprising a graded concentration layer having a relatively high content of the second oxide film forming element, carbonized/carburized layer or the like is formed on the thin metal layer. The metal-ceramic joined article thus obtained may be either used in high temperature oxidizing atmosphere as it is, or subjected to oxidization treatment on the surface before use. When the surface layer is oxidized, the second oxide layer that contains the second oxide film forming element formed on the surface thereof can be formed.

In this instance, the oxidization treatment temperature is set in accordance with the compositions of the thin metal layer and of the surface layer. In the case of an Fe-based or Ni-based heat resistant steel having a surface layer that contains relatively high content of Al, Cr, Si, etc. formed thereon, the oxidization treatment temperature is preferably in a range from 700 to 1000° C. Duration of heat treatment may be such that the first oxide layer can be formed uniformly on the surface of the thin metal layer. While optimum duration of heat treatment depends on the heat treatment temperature, thickness and composition of the thin metal layer and other factors, the duration is normally from several minutes to several tens of minutes. If a fixture made of carbon is used to apply a pressure when joining, a carbon layer and carbonized/carburized layer may be formed on the surface layer. The metallic component may be bonded either onto the carbonized/carburized layer after removing the carbon layer, or onto the surface layer after removing the surface layer and the carbonized/carburized layer. It is preferable to bond the metallic component onto the surface layer after removing the surface layer and the carbonized/carburized layer.

In the second and third methods described above, the step of forming the surface layer that contains a higher content of the second oxide film forming element (and the first oxide film forming element) than in the thin metal layer and the step of joining the thin metal layer and the ceramic member may be carried out simultaneously by placing a metal foil or powder made solely of the second oxide film forming element (and the first oxide film forming element) on the thin metal layer and carrying out heat treatment.

The metal-ceramic joined article thus obtained may be further provided with a metallic component bonded thereon as required. In this case, the metallic component may be bonded either directly on the second oxide layer, or via a brazing material or an intermediate layer. Alternatively, the metallic component or the like may be bonded onto the surface (or the surface layer from which the carbonized/carburized layer are removed), and the second oxide layer may be formed thereafter.

Now the action of the metal-ceramic joined article according to the present invention will be described. When the thin metal layer made of a heat resistant material having high heat resistance and/or high oxidization resistance is joined onto the ceramic member, the joining step is normally carried out while applying a pressure by means of a fixture made of carbon. However, a heat resistant material generally contains an element such as Fe, Cr, Mo, W, Ni or Ti that has tendency to be carbonized or form a solid solution with carbon, or tendency to be nitrided or form a solid solution with nitrogen. As a result, when carbon and/or nitrogen diffuses from the fixture made of carbon into the thin metal layer when joining, carbide or nitride is formed in the thin metal layer and causes significant decrease in heat resistance and/or oxidization resistance as well as mechanical properties of the thin metal layer. Consequently, putting the metal-ceramic joined article in such a condition into use in high temperature oxidizing atmosphere leads to oxidization of the thin metal layer which eventually exfoliates from the surface of the ceramic member.

When the thin metal layer that contains the first oxide film forming element is oxidized before joining, in contrast, the first oxide film that contains the first oxide film forming element is formed on the surface. When the thin metal layer whereon the first oxide film is formed and the ceramic member are placed one on the other and are heated to a predetermined temperature under a pressure applied by a fixture made of carbon, the first oxide film suppresses the diffusion of carbon and/or nitrogen into the thin metal layer. As a result, a decrease in the heat resistance and/or oxidization resistance of the thin metal layer due to the diffusion of carbon and/or nitrogen can be suppressed. Even when the metal-ceramic joined article is used in high temperature oxidizing atmosphere of 600° C. or higher, the metal-ceramic joined article that can maintain the mechanical and/or functional properties for a long period of time is obtained.

A metallic material that contains the second oxide film forming element is generally high in heat resistance and in oxidization resistance. This is because the second oxide film that contains an oxide of the second oxide film forming element and is high in resistance to oxidization and is dense is formed on the surface of the metallic material when such a metallic material is exposed to high temperature oxidizing atmosphere, so that diffusion of oxygen to the inside of the metallic material is suppressed. Moreover, while the second oxide film is gradually lost due to exfoliation, evaporation or other cause, disappearance of the second oxide film from the surface results in the diffusion of the second oxide film forming element in the metallic material to the surface, thus leading to the formation of a new second oxide film. Therefore, in order to maintain the heat resistance and oxidization resistance of such a metallic member for a long period of time, the content of the second oxide film forming element contained in the metallic member is preferably higher.

However, when the metallic member having high heat resistance and high oxidization resistance in the form of thin film is joined with the ceramic member, the content of the second oxide film forming element contained in the thin film becomes small. On the other hand, as the second oxide film forming element has high activity, when the thin metal layer that contains the second oxide film forming element and the ceramic member are joined together, the second oxide film forming element may be diffused into the metal-ceramic interface during the joining step and be consumed in the reaction with the ceramic material. This phenomenon may become conspicuous in a method where ionic property of the metal element is made use of to thereby forcibly cause interface reaction. As a result, the content of the second oxide film forming element contained in the thin metal layer decreases thus making it difficult to maintain not only short-term heat resistance and oxidization resistance but also long-term heat resistance and oxidization resistance.

In contrast, when the surface layer that has a high content of the second oxide film forming element is formed on the surface of the thin metal layer before joining and the thin metal layer is joined with the ceramic member, the second oxide film forming element diffuses from the surface layer toward the thin metal layer due to the heat applied during the joining step. As a result, a surface layer containing high concentration of the second oxide film forming element is formed on the surface of the thin metal layer.

As a result, even the thin metal film made of a material that has low heat resistance and/or low oxidization resistance can be rendered heat resistance and/or oxidization resistance. Moreover, even when the second oxide film forming element is consumed in the metal-ceramic interface during the joining step, heat resistance and/or oxidization resistance of the thin metal layer can be suppressed from decreasing. In addition, as the content of the second oxide film forming element contained in the thin metal layer increases due to diffusion, not only short-term but also long-term heat resistance and/or oxidization resistance can be ensured.

In addition, according to the present invention, it is not necessary to make the thin metal layer thicker for the purpose of maintaining long-term heat resistance and/or oxidization resistance of the thin metal layer. As a result, less residual stress is generated in the metal-ceramic interface so that durability and reliability of the metal-ceramic joined article are improved. Furthermore, it is not necessary to use the thin metal layer that contains a high content of the second oxide film forming element and a material having high workability can be used, and therefore the metal-ceramic joined article, having high durability and high reliability, can be made at a lower cost.

Generally speaking, when a metal element that acts as the second oxide film forming element as described above is added to the metallic member, the hardness of the metal member increases and it becomes difficult to add the element beyond the predetermined concentration and to make the thin metal layer thinner. However, according to the present invention, as the surface layer having a high content of the second oxide film forming element can be formed by diffusing the second oxide film forming element in the thin metal layer that has been made thin in advance, it is less likely to be subjected to the restriction described above.

### EXAMPLES

### Example 1

A metal foil I having a thickness of 20 μm was oxidized at temperature from 900 to 1000° C. in air atmosphere for 15 minutes. In this example, four kinds of alloy, Fe-20Cr-5Al-0.1La alloy, Ni-25Cr-1.5Al alloy, Ni-16Cr-7Fe-1.5Al alloy and Fe-22Cr-0.5Y-4Al alloy were used as the metal foil I. Then, both ends of a silicon nitride plate having a size of 4 mm by 2 mm each was sandwiched by the metal foils I, and the stack was held by a fixture made of carbon coated with a release agent to carry out diffusion-joining step. Diffusion-joining was carried out by heat treatment at 1100° C. in vacuum for five minutes while applying a pressure of 10 MPa.

### Example 2

Both ends of a silicon nitride plate having a size of 4 mm by 2 mm each was sandwiched by the metal foil I and a metal foil II (outside) 15 μm in thickness. In this example, three kinds of metal foil II, Al, Cr and Si were used. The stack was held by a fixture made of carbon coated with a release agent to carry out diffusion-joining step. Diffusion-joining was carried out by heat treatment at 1100° C. in vacuum for five minutes while applying a pressure of 10 MPa and applying an electric field.

### Example 3

An Al film 2 μm in thickness was formed on one side of the metal foil I by sputtering. Both ends of a silicon nitride plate having a size of 4 mm by 2 mm each was sandwiched by the metal foils I so that the Al film lay on the outside. The stack was held by a fixture made of carbon coated with a release agent to carry out diffusion-joining step. Diffusion-joining was carried out by heat treatment at 1100° C. in vacuum for five minutes while applying a pressure of 10 MPa.

### Example 4

The metal foil I was plated with Cr to a thickness of about 3 μm on both sides. Both ends of a silicon nitride plate having a size of 4 mm by 2 mm each was sandwiched by the metal foils I. The stack was held by a fixture made of carbon coated with a release agent to carry out diffusion-joining step. Diffusion-joining was carried out by heat treatment at 1100° C. in vacuum for five minutes while applying a pressure of 10 MPa and an electric field.

### Example 5

The metal foil I was coated with a thin layer of Si powder (particle size: 5 μm) by spraying on one side thereof. Both ends of a silicon nitride plate having a size of 4 mm by 2 mm each was sandwiched by the metal foils I so that Si powder coat layer lay on the outside. The stack was held by a fixture made of carbon coated with a release agent to carry out diffusion-joining step. Diffusion-joining was carried out by heat treatment at 1100° C. in vacuum for five minutes while applying a pressure of 10 MPa.

### Comparative Example 1

Both ends of a silicon nitride plate having a size of 4 mm by 2 mm each was sandwiched by the metal foils I that had not been treated. The stack was held by a fixture made of carbon coated with a release agent to carry out diffusion-joining step. Diffusion-joining was carried out by heat treatment at 1100° C. in vacuum for five minutes while applying a pressure of 10 MPa and applying an electric field.

Reaction products formed on the surface of the metal foil I were determined by X-ray diffraction for all the joined articles obtained in Example 1. Formation of carbide was not observed regardless of the material from which the metal foil I was formed.

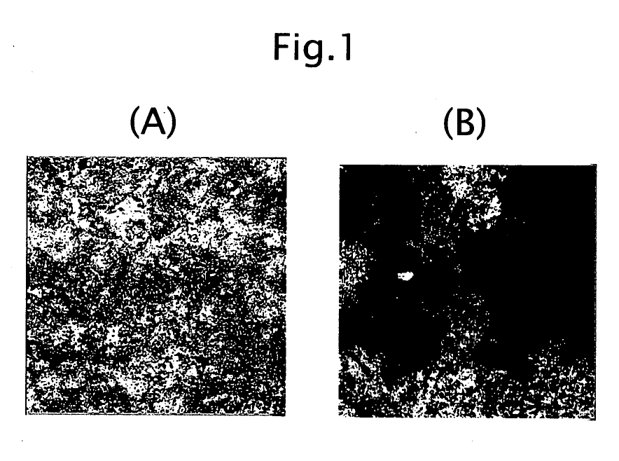

The surface of the metal foil I was subjected to element analysis by EPMA (Electron Probe Microanalyzer) for the joined articles obtained in Examples 2 to 5 and Comparative Example 1. FIG. 1 shows distribution (A) of Al concentration on the surface of the metal foil I of the joined articles obtained in Example 2 (the metal foil I was made of Fe-20Cr-5Al-0.1La alloy and the metal foil II was made of Al) and the distribution (B) of the joined article obtained in Comparative Example 1 (the metal foil I was made of Fe-20Cr-5Al-0.1La alloy), respectively. In FIG. 1, a brighter region shows a higher Al concentration.

From FIG. 1, it can be seen that Al concentration is low as a whole and varies greatly in the case of Comparative Example 1 where only the metal foil I was used, while Al concentration is high as a whole and is constant over the entire surface of the metal foil I in the case of Example 2 where the Al foil was placed on the metal foil I. This means that it is more likely that a very stable Al₂O₃ film is formed on the surface of the metal foil I so that higher resistance to oxidization and long-term resistance to oxidization can be achieved in the joined article of Example 2 than in the joined article of Comparative Example 1.

Although not shown, similar results could be obtained in all other examples, where high concentration of Al, Cr or Si was observed in the surface of the metal foil I, and it was confirmed that such a surface layer was formed as these elements were distributed uniformly over the entire surface of the metal foil I.

Embodiments of the present invention have been described in detail, however, it should be understood that the present invention is not limited to the embodiments described above, and various improvements and modifications are possible without deviating from the scope of the invention.

It will be appreciated from the above descriptions that the metal-ceramic joined article of the present invention can be used for structural components and functional components that are used in oxidizing atmosphere at a temperature of 600° C. or higher.

1. A metal-ceramic joined article comprising:
a ceramic member;
a thin metal layer joined onto the surface of said ceramic member; and
a surface layer formed on the surface of said thin metal layer, having a function to prevent carbon, nitrogen and/or oxygen diffusing into said thin metal layer.

2. The metal-ceramic joined article according to claim 1, wherein said thin metal layer is formed from a first oxide film forming element capable of forming a first oxide film having a function to prevent carbon and/or nitrogen diffusing into said thin metal layer, and said surface layer is said first oxide film formed by oxidizing the surface of said thin metal layer before joining.

3. The metal-ceramic joined article according to claim 2, wherein said first oxide film is made of a metal oxide having a generated free energy of 400 kJ/mol or less at 900° C.

4. The metal-ceramic joined article according to claim 2, wherein said first oxide film forming element is one or more elements selected from Al, Cr, Si, Mg, Nb, Mn, Ni, Ce, Ti, Zn and Ta.

5. The metal-ceramic joined article according to claim 1, wherein said surface layer comprises a layer which has a higher content of a second oxide film forming element, capable of forming a second oxide film which has a function to prevent oxygen diffusing into said thin metal layer, than that of said thin metal layer has.

6. The metal-ceramic joined article according to claim 5, wherein said surface layer comprises a graded concentration layer having a content of said second oxide film forming element which is gradually changed from the surface thereof toward said thin metal layer.

7. The metal-ceramic joined article according to claim 5, wherein said surface layer further comprises said second oxide film formed by oxidizing the surface of said thin metal layer after joining.

8. The metal-ceramic joined article according to claim 5, wherein said second oxide film is made of a metal oxide that has a generated free energy of 400 kJ/mol or less at 900° C.

9. The metal-ceramic joined article according to claim 5, wherein said second oxide film forming element is one or more elements selected from Al, Cr, Si, Mg, Nb, Mn, Ni, Ce, Ca, Ti, Zn and Ta.

10. The metal-ceramic joined article according to claim 5, wherein the content of said second oxide film forming element in said thin metal layer is 5% by weight or more.

11. The metal-ceramic joined article according to claim 5, wherein the content of Al in said thin metal layer is 5% by weight or more.

12. The metal-ceramic joined article according to claim 5, wherein the content of said second oxide film forming element in said thin metal layer is at least an amount necessary to form and maintain said second oxide film for 100 hours or more under use conditions at a high temperature of 1000° C. or higher.

13. The metal-ceramic joined article according to claim 1, wherein said thin metal layer further comprises a rare earth element.

14. A method for producing a metal-ceramic joined article comprising:
an oxidation step wherein the surface of the thin metal layer comprising the first oxide film forming element is oxidized, so as to form the first oxide film on at least one of the surfaces of said thin metal layer; and
a joining step wherein said thin metal layer and a ceramic member are placed one on the other and are subjected to a heat treatment under pressure.

15. A method for producing a metal-ceramic joined article comprising:
a surface layer forming step wherein the surface layer that contains the second oxide forming element at a higher content than that in the thin metal layer is formed on at least one of the surfaces of said thin metal layer; and
a joining step wherein said thin metal layer and a ceramic member are placed one on the other and are subjected to heat treatment under pressure, so that said surface layer is disposed on the outside.

16. The method for producing a metal-ceramic joined article according to claim 15, wherein said second oxide film forming element is one or more elements selected from Al Cr, Si, Mg, Nb, Mn, Ni, Ce, Ca, Ti, Zn, and Ta.

17. The method for producing a metal-ceramic joined article according to claim 15, further comprising an oxidization step wherein said surface layer is oxidized after joining, so as to form the second oxide film on the outermost layer.

18. The method for producing a metal-ceramic joined article according to claim 14, wherein said joining step comprises application of an electric field during the heat treatment.
